(19) United States
(12) Patent Application Publication
(10) Pub. No.: US 2014/0029939 A1
(43) Pub. Date: Jan. 30, 2014

(54) Blocking Estimation To Evaluate Connection Blocking In Flexible Optical WDM Networks

(71) Applicant: NEC Laboratories America, Inc., Princeton, NJ (US)

(72) Inventors: Ankitkumar Patel, Plainsboro, NJ (US); Philip Ji, Plainsboro, NJ (US); Jason Jue, Plano, TX (US)

(73) Assignee: NEC Laboratories America, Inc., Princeton, NJ (US)

(21) Appl. No.: 13/951,461

(22) Filed: Jul. 26, 2013

Related U.S. Application Data
(60) Provisional application No. 61/675,970, filed on Jul. 26, 2012.

(51) Int. Cl. H04B 10/07

(52) U.S. Cl. CPC H04B 10/07
USPC 398/34

(57) ABSTRACT

A method for blocking estimation to evaluate connection blocking in flexible optical wavelength division multiplexing WDM networks includes a novel Markovian model to analyze the steady state probabilities and connection blocking probability along a fiber in FWDM networks and finding the state dependent arrival rate for each type of line rate on a fiber

### RELATED APPLICATION INFORMATION

This application claims priority to provisional application Ser. No. 61/675,970 filed on Jul. 26, 2012, the contents thereof are incorporated herein by reference.

### BACKGROUND

The present invention relates optical communications, and, more particularly, to blocking estimation to evaluate connection blocking in flexible optical wavelength division multiplexing WDM networks.

In conventional wavelength division multiplexing (WDM) optical networks, the spectrum allocation to the WDM channels (determined from the channel spacing) is fixed, and remains the same throughout the network operations. These channels are centered on standard ITU-T channel grid such as specified according to ITU-T standard G.694.1 [ITU-T]. We refer to such networks as the fixed grid optical WDM networks. In fixed grid networks, the fixed amount of spectrum is assigned to all connections irrespective of their data rates, which may lead to an inefficient utilization of spectral resources (FIG. 1(a)). Such a network is rigid and cannot provide optimum spectral efficiency.

Envisioning the requirement for higher spectral efficiency to support the future traffic volume, there has been several efforts for relaxing the constraint of fixed spectral allocation in optical WDM networks, which we refer as Flexible optical WDM networks (FWDM). The FWDM networks consist of optical channels supporting heterogeneous line rates using variable amounts of spectrum as shown in FIG. 1(b) as opposed to fixed grid networks.

A flexible spectrum assignment in FWDM networks improves spectral efficiency by avoiding over-provisioning of spectral resources for the sub-wavelength granularity traffic and guard bands between multiple channels used to support the super-wavelength granularity traffic compared to fixed grid networks. For example, instead of allocating 50 GHz of spectrum to a channel with 10 Gb/s line rate as in fixed grid networks, 25 GHz of optimum spectrum is allocated to the channel in FWDM networks. On the other hand, instead of establishing four 100 Gb/s channels using 200 GHz of spectrum (including guard bands) for 400 Gb/s data rate, a single channel of 400 Gb/s line rate can be established within continuous 75 GHz of spectrum by eliminating guard bands. On the other hand, due to the flexibility in spectrum allocation, a control plane in FWDM networks must observe additional (1) spectral continuity constraint which is defined as an allocation of the same amount of spectrum on each link along the route, and (2) spectral conflict constraint which is defined as non-overlapping spectrum allocation to channels routed over the same fiber, along with the conventional (3) wavelength continuity constraint which is defined as an allocation of spectrum at the same center wavelength over all links along the route while provisioning channels.

In a dynamic traffic scenario, connections arrive and depart with statistical distributions. Upon an arrival of a connection, network resources are reserved and upon its departure, the reserved resources are released for future connections. Open issues in provisioning connections in a dynamic traffic scenario are how to route the connections, how to assign wavelengths to connections, and how to allocate spectrum to connections such that connection blocking is minimized. This problem is referred to as the dynamic routing, wavelength assignment, and spectrum allocation problem in FWDM networks. In a dynamic traffic scenario, statistical arrivals and departures of channels with heterogeneous spectral requirements leads to spectral fragmentation that partitions the continuous spectral band into smaller spectral-islands as shown in FIG. 2. A channel may be blocked over a fiber in spite of an availability of sufficient amount of spectrum for the channel if the available spectrum is fragmented and not continuous. Additionally, this channel blocking further increases in the network due to the observance of the wavelength continuity, spectral continuity, and spectral conflict constraints if the channel is routed over multiple fragmented fibers. For the routing sub-problem, the shortest path-based fixed routing is one of the attractive solutions for network operators since such scheme occupies minimum network resources. In this invention, we develop a novel blocking estimation method to evaluate the blocking probability of a connection that is routed over the fixed shortest path and is assigned a wavelength randomly at which sufficient amount of spectrum is available in FWDM networks.

In FWDM networks, the spectrum profile of a fiber can be continuous or discrete in the frequency domain. Since a continuous spectrum profile may cause significant management and control plane overheads, network operators prefer to maintain a discrete spectrum profile with sufficient granularity such that network performance is not sacrificed. In a discretized spectrum profile, the smallest unit of spectrum is referred to as a wavelength slot. The spectrum of a channel is defined in terms of the number of consecutive wavelength slots. The lowest index of allocated wavelength slots to a channel is referred to as a wavelength of the channel. A wavelength slot can be either in an available state or in an occupied state. The state of this discretized spectrum of a fiber is referred to as the spectrum availability profile. The problem is formally defined as follows.

We are given a physical network topology G(V, E), where V is a set of ROADM nodes and E is a set of fiber links connecting a pair of nodes. A traffic demand requesting a connection between a source node s and a destination node d with requested data rate a is denoted as R(s, d, σ). We are given arrival and departure distributions of such traffic demands. The network supports a set of line rates L, and each line rate l ∈ L requires xₗ GHz of spectrum. The network offers Z GHz of total spectrum. The transponders are assumed to have variable transmitting and receiving capabilities, and the network is assumed to have ideal transport layer with no wavelength conversion capability at intermediate nodes. For the given accuracy threshold of &, we need to design a method to accurately estimate the blocking of a connection that is routed over the fixed shortest path and is assigned a wavelength randomly at which sufficient amount of spectrum is available.

In fixed grid networks, the same amount of spectrum is assigned to all channels and the channel center frequency is fixed. Thus, the minimum granularity at which spectrum is fragmented is the standardized channel spacing. This channel spacing is used to support a channel with any granularity in the network. Thus, an arrival of a connection occupies a single wavelength slot and upon its departure, this wavelength slot is released. In efforts by others, the methods are developed to estimate the blocking of a connection that is routed over fixed shortest path or least loaded path and is assigned a wavelength randomly in fixed grid networks. These methods employ a well-known M/M/K/K queuing model to estimate the connection blocking on a single fiber, and using a well-known reduced load approximation procedure and this M/M/K/K queuing model, methods are designed to estimate the blocking on multi-hop connections.

In FWDM networks, the spectrum is slotted at the granularity of the greatest common factor of the spectrum required by the offered set of line rates L. Thus, a channel in FWDM occupies an integer number of consecutive wavelength slots equivalent to the required spectrum by the channel, and these consecutive wavelength slots are released upon its departure. In such a spectrum allocation scenario, a fiber cannot be modeled as an M/M/K/K queuing model, and thus, the existing fixed grid blocking estimation methods cannot be applicable to estimate the blocking of single-hop or multi-hop connections in FWDM networks.

Accordingly, there is a need for a method to address the issue of evaluating connection blocking in FWDM networks.

### SUMMARY OF THE INVENTION

A computer implemented method for blocking estimation to evaluate connection blocking in flexible optical wavelength division multiplexing WDM networks includes initializing blocking of a connection operating at line rate l along the route R, with blocking probability B^{l}_{R}, to 0, and initializing the blocking of the connection in the previous iteration b^{l}_{R} to 0, recording the blocking connection in the current iteration B^{l}_{R} into the blocking of the previous iteration b^{l}_{R} for each line rate l and each route R, determining steady state probabilities G_{Nj, Xj} of each fiber link j using a Markovian model which includes finding a state transition diagram for each fiber link j, determining a state dependent arrival rate for each line rate l over each fiber j, α^{l}ⱼ(Nⱼ, Xⱼ), finding the blocking of a connection, finding the difference in the blocking probability of a connection operating at each link rate l along each route R between subsequent iterations, if the difference is smaller than an accuracy threshold ε, then the method stops, otherwise the method repeats the step of recording the blocking connection, and determining a blocking of a connection operating at each line rate l along each route R, B^{l}_{R}.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram comparing (a) fixed grid WDM network and (b) a flexible WDM network;

FIG. 2 is a depiction of fragmented spectrum of an optical fiber;

FIG. 3 is a state transition diagram of a Markovian model utilized by the inventive method;

FIG. 4 is a flow chart of the blocking estimation method, in accordance with the invention; and

FIG. 5 is a flow chart of a permutation process, in accordance with the invention

### DETAILED DESCRIPTION OF PREFERRED EMBODIMENTS

The present invention is directed to a blocking estimation method to evaluate the connection blocking in FWDM networks. A single fiber in FWDM networks is analyzed using a novel Markovian queuing model, and this model is employed to estimate the blocking of a single-hop connection in FWDM networks. Using the developed Markovian model and a reduced load approximation procedure, we designed the blocking estimation method to evaluate blocking of multi-hop connections in FWDM networks.

In fixed grid networks, the channel spacing is fixed, and an arrival of a connection occupies the same amount of spectrum irrespective of the operating line rate. Thus, if the spectrum is slotted at the granularity of fixed channel spacing, then the arrival of each connection occupies a single wavelength slot, and blocking probability of a single-hop point-to-point connection can easily be estimated using a known M/M/K/K Markovian queuing model. However, the same model is not applicable in FWDM networks since an arrival of a flexible channel occupies flexible amounts of spectrum depending on the operating line rate. Thus, if the spectrum is slotted at the granularity of the greatest common factor of spectrum required by the offered line rates, then unlike fixed grid networks, a connection occupies integer number of consecutive wavelength slots equivalent to the desired spectrum for the line rate. In such scenario, the existing M/M/K/K queuing model is no longer applicable. In this invention, we develop a novel Markovian model that can be used to estimate the performance of a fiber in FWDM networks in which an arrival of a flexible connection occupies an integer number of consecutive slots in the spectrum availability profile. In this method, we assume that wavelength slots are independent and neglect the correlations between wavelength slots caused due to the consecutive slots assignment.

A significant issue in developing a Markovian model is how to represent the state of a fiber. If states of a fiber are maintained accurately by keeping track the occupancy of each wavelength slot and the number of connections of each type of line rates routed over the fiber, then the complexity of the state space is O(2^{γ}Nₘₐₓ^{|L|}), where

$$γ = ⌊ \frac{Z}{δ} ⌋$$

is the number of wavelength slots in spectrum availability profile,

$${m}_{l} = ⌊ \frac{{x}_{l}}{δ} ⌋$$

is the number of wavelength slots required by a line rate l, and

$${N}_{max} = ⌈ \frac{γ}{{min}_{l ∈ L} {m}_{l}} ⌉$$

is the maximum number of connections that can be supported over the link. In this approach, the state space increases exponentially with the number of offered line rates, the offered total spectrum, and the granularity at which spectrum is discretized. One approach is to represent states of a fiber in terms of the number of connections for each type of line rate with the assumption that connections are randomly and uniformly distributed over the spectrum, which reduces the complexity of state space to O(Nₘₐₓ^{|L|}). However, this complexity is still intractable as the offered set of line rates increases. In this study, we consider a simpler approach in which the state of a fiber link j is concisely represented by two parameters, (1) the total number of connections routed over the link, denoted as Nⱼ, and (2) total number of occupied wavelength slots in the spectrum, denoted as Xⱼ.

$$\begin{matrix}{N}_{j} = {\sum }_{l ∈ L} {n}_{j}^{l} & ( 1 ) \\ {X}_{j} = {\sum }_{l ∈ L} {n}_{j}^{l} \times {m}_{l} , & ( 2 )\end{matrix}$$

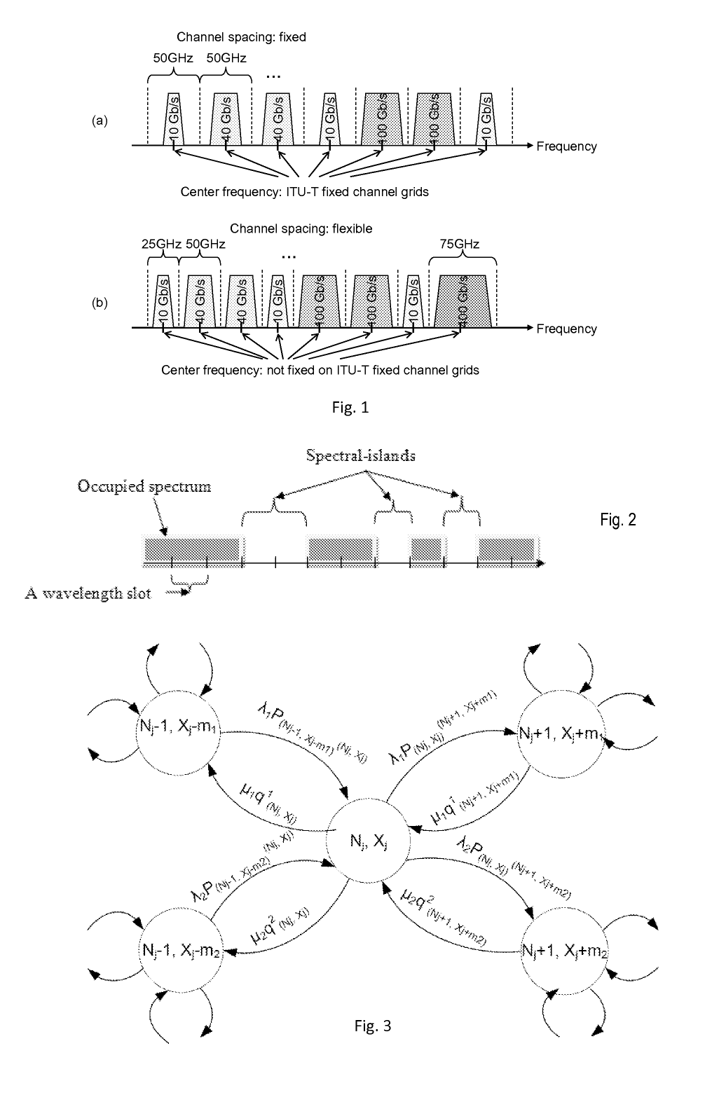

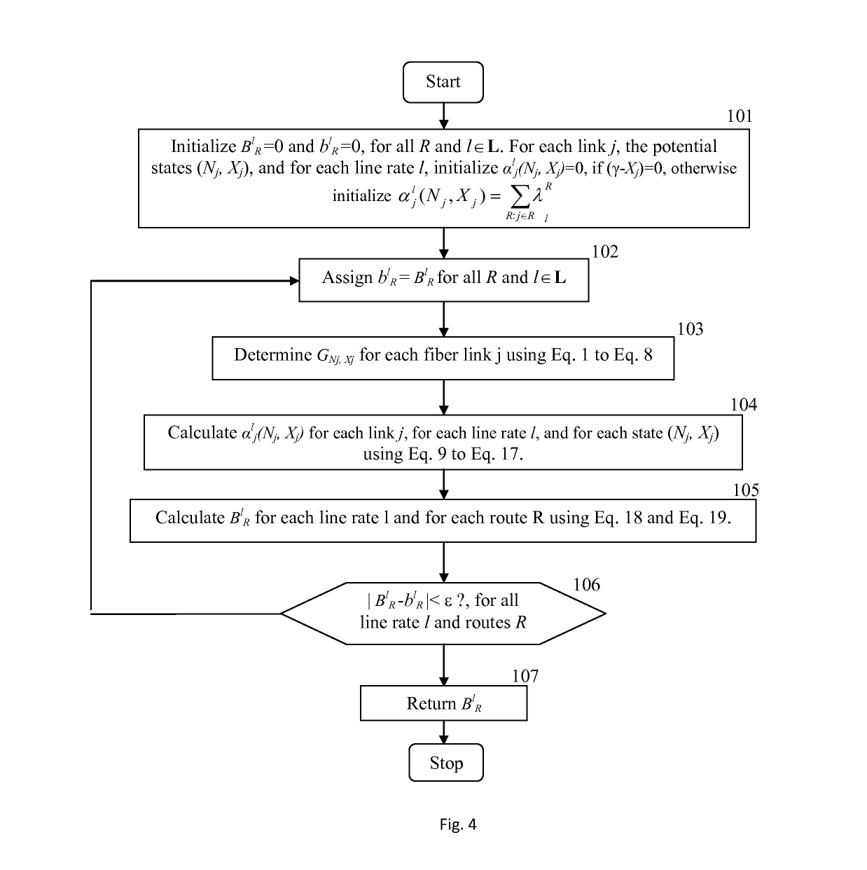

The term n^{l}ⱼ denotes the number of connections that operates at line rate l ∈ L. In this approach, the complexity of the state space is O(Nₘₐₓ×γ) that increases polynomially with the number of connections, the amount of offered spectrum, and the granularity at which the spectrum is discretized. The exact number of connections routed over the fiber link for each type of line rates can be obtained from the state (Nⱼ,Xⱼ) by applying the methods to solve the system of linear equations over Eq. 1 and Eq. 2 if the network supports up to two types of line rates. However, for more than two types of line rates, we can obtain the distribution of the number of connections for each type of line rate by applying the methods to solve the system of linear diophantine equations [EDomenjoud] over Eq. 1 and Eq. 2. Here, we develop an initial Markovian model for the network that supports up to two types of line rates while ignoring correlations between wavelength slots introduced by the allocation of consecutive wavelength slots. We also investigate the blocking estimation procedure to evaluate the blocking of multi-hop connections with the assumption that the fiber links are not correlated. We assume that connections operating at line rate l arrive with the Poisson distribution at rate λₗ and the connection holding time is exponentially distributed with an average holding time (l/μ_{L}). Let B^{l}_{R} is the blocking probability of a connection operating at line rate l along the route R={1, 2, 3, . . . j}, λₗ^{R} is the arrival rate of a connection operating at line rate l along the route R, G_{Nj, Xj} is the steady state probability of a fiber j being in a state (Nⱼ, Xⱼ), and α^{l}ⱼ(Nⱼ, Xⱼ) is the arrival rate of a connection operating at line rate l on a fiber j when the state of the fiber is (Nⱼ, Xⱼ). Using these parameters, the blocking estimation procedure (as shown in FIG. 1) is described as follows.

At the first step 101, the inventive method initializes the blocking of a connection operating at line rate l along the route R, B^{l}_{R}, to 0. The blocking of the connection in the previous iteration b^{l}_{R} is also initialized to 0. For each link j, the potential states (Nⱼ, Xⱼ), and for each line rate l, the method initializes α^{l}ⱼ(Nⱼ, Xⱼ)=0, if (γ-Xⱼ)=0, otherwise it initializes

$${α}_{j}^{l} ( {N}_{j} , {X}_{j} ) = {\sum }_{R \text{:} j ∈ R} {λ}_{I}^{R} .$$

Then at step 102 the invention records the blocking in the current iteration B^{l}_{R} into the blocking of previous iteration b^{l}_{R} for each line rate l and each route R.

In the third step, 103, the invention determines the steady state probabilities G_{Nj, Xj} of each fiber link j using the Markovian model. The inventive method first finds the state transition diagram for each fiber link j as shown in FIG. 3.

FIG. 3 represents the state diagram of a fiber link j when the network supports two types of line rates L={2}. An arrival of a connection with line rate l triggers a transition from state (Nⱼ,Xⱼ) to state (Nⱼ+1, Xⱼ+mₗ) with transition rate λₗ×p^{(Nj-1; Xj+ml)}_{(Nj, Xj)}, where p^{(Nj+1;Xj+ml)}_{(Nj, Xj)} is the probability that the arriving connection is not blocked and is determined as shown in Eq. 3

$${p}_{( {N}_{j} , {X}_{j} )}^{( {N}_{j} + 1 , {X}_{j} + {m}_{l} )} = 1 - \frac{{a}_{( {N}_{j} + γ - {X}_{j} ) , ( γ - {X}_{j} )}^{{m}_{l}}}{{P}_{γ}^{{N}_{j}}} \qquad ( 3 )$$

The term a^{ml}_{(Nj+γ-Xj)(γ-Xj)} represents the number of permutations of Nⱼ requests in a state (Nⱼ, Xⱼ) that does not contain at least mᵢ consecutive wavelength slots. a^{ml}_{(Nj+γ-Xj)(γ-Xj)} can be determined using the recurrence formula shown in Eq. 4.

$${a}_{( {N}_{j} + γ - {X}_{j} ) , ( γ - {X}_{j} )}^{{m}_{l}} = ( {N}_{j} + γ - {X}_{j} - γ + {X}_{j} ) {a}_{( {N}_{j} + γ - {X}_{j} - 1 ) , ( γ - {X}_{j} )}^{{m}_{l}} + ( {N}_{j} + γ - {X}_{j} - γ + {X}_{j} ) {a}_{( {N}_{j} + γ - {X}_{j} - 2 ) , ( γ - {X}_{j} - 1 )}^{{m}_{l}} \qquad ( 4 )$$

The term P_{γ}^{Nj} represents the number of permutations of Nⱼ requests in a state (Nⱼ, Xⱼ) among y wavelength slots. Upon departure of a connection with line rate l, the link transits from state (Nⱼ, Xⱼ) to state (Nⱼ−1, Xⱼ−mₗ) with rate μₗ×q^{l}_{(Nj, Xj)}, where qⁱ_{(Nj, Xj)} represents the expected number of connections operating at line rate l in a state (Nⱼ, Xⱼ). The number of connections operating at each line rate can be obtained from Eq. 1 and Eq. 2. In the proposed model, a fiber link can be in one of the v states at any instance, where

$$v = 1 + ⌊ \frac{γ}{{m}_{j}} ⌋ + {\sum }_{k = 0}^{\{ ⌊ \frac{γ}{{m}_{j}} ⌋ \vert j \neq i \}} ⌊ \frac{γ - ( k \times {m}_{j} )}{{m}_{i}} ⌋ \qquad ( 5 )$$

The proposed model is homogeneous and irreducible since the transition rates are time independent, and any state can be reached from any other state. Let G_{Nj,Xj} be the steady state probability of being in a state (Nⱼ, Xⱼ). The steady state probabilities can be derived by solving a set of linear global balance equations and Eq. 6, where the global balance equation for each state (Nⱼ, Xⱼ) can be obtained by equating a cumulative arrival rate from other states to the state (Nⱼ, Xⱼ) with the cumulative departure rate from the state (Nⱼ, Xⱼ) to other states as shown in Eq. 7.

$$\begin{matrix}{\sum }_{{N}_{j} , {X}_{j}} {G}_{{N}_{j} , {X}_{j}} = 1 & ( 6 ) \\ {λ}_{1} {p}_{( {N}_{j} - 1 , {X}_{j} - {m}_{1} )}^{( {N}_{j} , {X}_{j} )} {G}_{{N}_{j} - 1 , {X}_{j} - {m}_{1}} + {λ}_{1} {p}_{{N}_{j} - 1 , {X}_{j} - {m}_{2}}^{{N}_{j} , {X}_{j}} {G}_{{N}_{j} - 1 , {X}_{j} - {m}_{2}} + {μ}_{1} {q}_{( {N}_{j} + 1 , {X}_{j} + {m}_{1} )}^{1} {G}_{{N}_{j} + 1 , {X}_{j} + {m}_{1}} + {μ}_{2} {q}_{( {N}_{j} + 1 , {X}_{j} + {m}_{2} )}^{2} {G}_{{N}_{j} + 1 , {X}_{j} + {m}_{2}} = ( {μ}_{1} {q}_{( {N}_{j} , {X}_{j} )}^{1} + {μ}_{2} {q}_{( {N}_{j} , {X}_{j} )}^{2} + {λ}_{1} {p}_{( {N}_{j} , {X}_{j} )}^{( {N}_{j} + 1 , {X}_{j} + {m}_{1} )} + {λ}_{2} {p}_{( {N}_{j} , {X}_{j} )}^{( {N}_{j} + 1 , {X}_{j} + {m}_{2} )} ) {G}_{{N}_{j} , {X}_{j}} & ( 7 )\end{matrix}$$

Finally, the blocking probability of a connection operating at line rate l on a fiber j, C^{l}ⱼ, is obtained from the steady state probabilities as shown in Eq. 8.

$${C}_{j}^{l} = {\sum }_{( {N}_{j} {X}_{j} ) \vert γ - {X}_{j} \geq {m}_{l}} {G}_{{N}_{j} , {X}_{j}} \times ( ( 1 - {p}_{( {N}_{j} , {X}_{j} )}^{( {N}_{j} + 1 , {X}_{j} + {m}_{l} )} ) \times \frac{{λ}_{l}}{{\sum }_{k} {λ}_{k}} ) + {\sum }_{( {N}_{j} {X}_{j} ) \vert γ - {X}_{j} < {m}_{l}} {{G}_{N}}_{j} , {X}_{j} \qquad ( 8 )$$

104: In this step, the method determines the state dependent arrival rate for each line rate l over each fiber j, α^{l}ⱼ(Nⱼ, Xⱼ) as follows.

Let Y_{R} be the maximum number of consecutive wavelength slots available along the route R subject to the wavelength continuity, spectral continuity, and spectral conflict constraints, and (N,X)={(N1,X1), (N2,X2), . . . , (Nj ,Xj)} be a set of fiber states along the route. The probability of lacking the sufficient number of consecutive wavelength slots along the route conditioned on the state of each fiber link along the route, pₘₗ(N,X), can be determined as shown in Eq. 9 and Eq. 10,

$$\begin{matrix}{p}_{{x}_{i}} ( ℕ , 𝕏 ) = Pr ( \begin{matrix}At least {m}_{l} consecutive slots are not available \\ on at least one of the fibers along the route\end{matrix} ) + ( \begin{matrix}Pr ( \begin{matrix}At least {m}_{l} consecutive slots are not \\ \begin{matrix}aligned / At least {m}_{l} consecutive slots are \\ available on each fiber along the route\end{matrix}\end{matrix} ) * \\ Pr ( \begin{matrix}At least {m}_{l} consecutive slots are \\ available on each fiber along the route\end{matrix} )\end{matrix} ) & ( 9 ) \\ {p}_{x l} ( ℕ , 𝕏 ) = Pr [ {Y}_{R} < {m}_{l} \vert {S}_{1} = ( {N}_{1} , {X}_{1} ) , {S}_{2} = ( {N}_{2} , {X}_{2} ) , … , {S}_{j} = ( {N}_{j} , {X}_{j} ) ] = ( \begin{matrix}{\sum }_{k = 1}^{k = j} Pr ( {Y}_{\{ k \}} < {m}_{l} ) - \\ {\sum }_{( k , f : 1 \leq k < f \leq j )} ( Pr ( {Y}_{\{ k \}} < {m}_{l} ) \times Pr ( {Y}_{\{ f \}} < {m}_{l} ) ) + \\ {\sum }_{( k , f , z : 1 \leq k < f < z \leq j )} ( \begin{matrix}Pr ( {Y}_{\{ k \}} < {m}_{l} ) \times \\ Pr ( {Y}_{\{ f \}} < {m}_{l} ) \times Pr ( {Y}_{\{ z \}} < {m}_{l} )\end{matrix} ) - \\ … + {( - 1 )}^{j - 1} {\prod }_{k = 1}^{k = j} ( Pr ( {Y}_{\{ k \}} < {m}_{l} )\end{matrix} ) + ( \begin{matrix}Pr [ {Y}_{R} < {m}_{l} \vert {Y}_{\{ 1 \}} \geq {m}_{l} , {Y}_{\{ 2 \}} \geq {m}_{l} , … , {Y}_{\{ j \}} \geq {m}_{l} ] \times \\ {\prod }_{k = 1}^{k = j} Pr ( {Y}_{\{ k \}} \geq {m}_{l} )\end{matrix} ) & ( 10 )\end{matrix}$$

The term Y_{{j}} denotes the maximum number of consecutive wavelength slots on a fiber j. The spectrum profile of a route does not contain the sufficient number of consecutive wavelength slots if such slots are not available on at least one of the fibers along the route. Alternatively, in spite of the availability of such slots on all fibers, the route does not contain at least the required number of consecutive slots if these available slots are not aligned on all fibers according to the spectral continuity constraint. The first term of Eq. 10 is derived using the Inclusion-Exclusion principle over the fiber links along the route, where Pr(Y_{{j}}<mₗ) is derived using the recurrence formula as shown in Eq. 11.

$$Pr ( {Y}_{\{ j \}} < {m}_{l} ) = \frac{{a}_{( {N}_{j} + γ - {X}_{j} ) , ( γ - {X}_{j} )}^{{m}_{l}}}{{P}_{γ}^{{N}_{j}}} \qquad ( 11 )$$

The second term of Eq. 10, Pr[Y_{R}<mₗ|Y_{{1}}≧mₗ, Y_{{2}}≧mᵢ, . . . , Y_{{j}}≧mₗ], is also obtained using the Inclusion-Exclusion principle over wavelength slots 1≦k≦γ as shown in Eq. 12.

$$Pr [ {Y}_{R} < {m}_{l} \vert {Y}_{\{ 1 \}} \geq {m}_{l} , {Y}_{\{ 2 \}} \geq {m}_{l} , … , {Y}_{\{ j \}} \geq {m}_{l} ] = 1 - ( \begin{matrix}{\sum }_{k = 1}^{k = γ} Pr ( {Y}_{R}^{k} \geq {m}_{l} ) - \\ {\sum }_{( k , f : 1 \leq k < f \leq γ )} ( Pr ( {Y}_{R}^{k} \leq {m}_{l} ) \times Pr ( {Y}_{R}^{f} \leq {m}_{l} ) ) + \\ {\sum }_{( k , f , z : 1 \leq k < f < z \leq γ )} ( \begin{matrix}Pr ( {Y}_{R}^{k} \geq {m}_{l} ) \times \\ Pr ( {Y}_{R}^{f} \geq {m}_{l} ) \times Pr ( {Y}_{R}^{z} \geq {m}_{l} )\end{matrix} ) - \\ … + {( - 1 )}^{γ - 1} \times {\prod }_{k = 1}^{k = γ} ( Pr ( {Y}_{R}^{k} < {m}_{l} )\end{matrix} ) \qquad ( 12 )$$

In Eq. 12, Pr(Y^{k}_{R}≧mₗ) denotes the probability of having at least mₗ consecutive aligned slots along the route R starting at wavelength slot k, which can be determined using the wavelength and spectral continuity constraints as shown in Eq. 13.

$$Pr ( {Y}_{R}^{k} \geq {m}_{l} ) = {\prod }_{i = 1}^{i = j} Pr ( {Y}_{\{ i \}}^{k} \geq {m}_{l} ) \qquad ( 13 )$$

where Pr(Y^{k}_{{i}}≧mₗ) denotes the probability of having at least mₗ consecutive slots on a fiber i starting at wavelength slot k, which can be determine using Eq. 14.

$$Pr ( {Y}_{\{ i \}}^{k} \geq {m}_{i} ) = \frac{\begin{matrix}Number of permutations \\ of {N}_{i} connections of state ( {N}_{i} , {X}_{i} )\end{matrix}}{{P}_{γ}^{{N}_{i}} - {a}_{{N}_{i} - γ - {X}_{i}}^{{m}_{l}}} \qquad ( 14 )$$

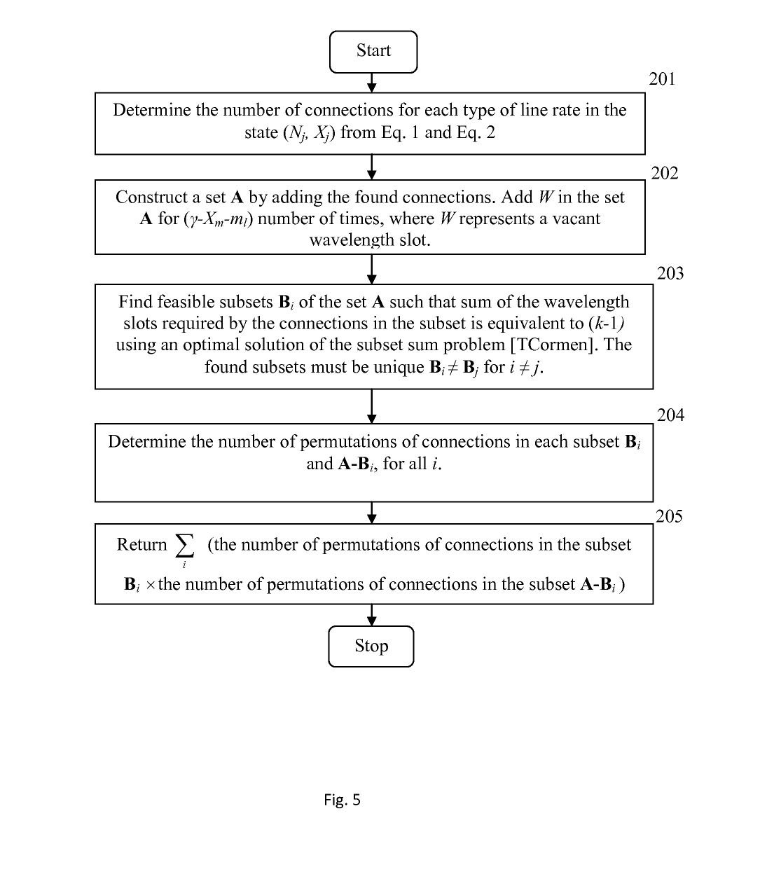

In Eq. 14, the denominator represents the number of permutations of connections with at least mₗ consecutive wavelength slots in the state (Nᵢ, Xᵢ) of a fiber i, and the numerator, the number of permutations of connections with at least mₗ consecutive wavelength slots starting from a wavelength slot k, is determined using the permutation method (as shown in Flowchart of FIG. 5).

For the Poisson arrival of connections and given the state (Nⱼ, Xⱼ) of a link j, the time until the next arrival of a connection operating at line rate l is exponentially distributed with parameter α^{l}ⱼ(Nⱼ, Xⱼ). This call set up rate on link j, when Nⱼ connections are routed over the link j occupying Xⱼ wavelength slots, is obtained from the cumulative arrival rate of connections operating at line rate l over the routes that contain link j as a member as shown in Eq. 15.

$$\begin{matrix}{a}_{j}^{l} ( {N}_{j} , {X}_{j} ) = 0 if ( γ - {X}_{j} ) < {m}_{l} \\ = {\sum }_{R : j ∈ R} {λ}_{l}^{R} \times Pr ( {Y}_{R} \geq {m}_{l} \vert {S}_{j} = ( {N}_{j} , {X}_{j} ) ) if ( γ - {X}_{j} ) \geq {m}_{l}\end{matrix} \qquad ( 15 )$$

In Eq. 15, λ^{R}ₗ is the arrival rate of connections operating at line rate l over the route R. If a route R consists of a single link {j} and (γ−Xⱼ)≧mₗ, then Pr(Y_{R}≧mₗ|Sⱼ=(Nⱼ, Xⱼ))=1 in Eq. 15. For a multihop route R={1, 2, . . . , k}, Pr(Y_{R}≧mₗ|Sⱼ=(Nⱼ, Xⱼ)) is determined using the total probability theorem as shown in Eq. 16. Eq. 16 can be simplified using the assumption of link independence as shown in Eq. 17.

$$\begin{matrix}Pr ( {Y}_{R} \geq {m}_{l} \vert {S}_{j} = ( {N}_{j} , {X}_{j} ) ) = {\sum }_{[ ( {N}_{1} , {X}_{1} ) \vert ( γ - {X}_{1} ) \geq {m}_{l} ]} {\sum }_{[ ( {N}_{2} , {X}_{2} ) \vert ( γ - {X}_{2} ) \geq {m}_{l} ]} … {\sum }_{[ ( {N}_{j} - 1 , {X}_{j} - 1 ) \vert ( γ - {X}_{j} - 1 ) \geq {m}_{l} ]} {\sum }_{[ ( {N}_{j} + 1 , {X}_{j + 1} ) \vert ( γ - {X}_{j} + 1 ) \geq {m}_{l} ]} … {\sum }_{[ ( {N}_{k} - 1 , {X}_{k} - 1 ) \vert ( γ - {X}_{k} - 1 ) \geq {m}_{l} ]} {\sum }_{[ ( {N}_{k} , {X}_{k} ) \vert ( γ - {X}_{k} ) \geq {m}_{l} ]} [ \begin{matrix}Pr ( \begin{matrix}{Y}_{R} \geq {m}_{l} / {S}_{1} = ( {N}_{1} , {X}_{1} ) , {S}_{2} = \\ ( {N}_{2} , {X}_{2} ) , … , {S}_{k} = ( {N}_{k} , {X}_{k} )\end{matrix} ) \times \\ ( Pr [ \begin{matrix}{S}_{1} = ( {N}_{1} , {X}_{1} ) , {S}_{2} = \\ ( {N}_{2} , {X}_{2} ) , … , {S}_{j - 1} = \\ ( {N}_{j - 1} , {X}_{j - 1} ) , {S}_{j + 1} = \\ ( {N}_{j + 1} , {X}_{j + 1} ) , … , {S}_{k - 1} = \\ ( {N}_{k - 1} , {X}_{k - 1} ) , {S}_{k} = \\ ( {N}_{k} , {X}_{k} ) / {S}_{j} = ( {N}_{j} , {X}_{j} )\end{matrix} ] )\end{matrix} ] & ( 16 ) \\ Pr ( {Y}_{R} \geq {m}_{l} \vert {S}_{j} = ( {N}_{j} , {X}_{j} ) ) = {\sum }_{( ( {N}_{1} , {X}_{1} ) \vert ( γ - {X}_{1} ) \geq {m}_{l} )} {\sum }_{( ( {N}_{2} , {X}_{2} ) \vert ( γ - {X}_{2} ) \geq {m}_{l} )} … {\sum }_{( ( {N}_{j} - 1 , {X}_{j} - 1 ) \vert ( γ - {X}_{j} - 1 ) \geq {m}_{l} )} {\sum }_{( ( {N}_{j} + 1 , {X}_{j + 1} ) \vert ( γ - {X}_{j} + 1 ) \geq {m}_{l} )} … {\sum }_{( ( {N}_{k} , {X}_{k} ) \vert ( γ - {X}_{k} ) \geq {m}_{l} )} ( \begin{matrix}( 1 - {p}_{{m}_{l}} ( ℕ , 𝕏 ) ) \times \\ {\prod }_{( i \vert i ∈ R - \{ j \} )} {G}_{( {N}_{i} {X}_{i} )}\end{matrix} ) & ( 17 )\end{matrix}$$

105: In this step, the method finds the blocking of a connection using Eq. 18 and Eq. 19 as follows.

The blocking of a connection along the multi-hop route R={1, 2, 3, . . . , j} can be determined as shown in Eq. 18, where the second equality is obtained with the assumption of link independence.

$$\begin{matrix}{B}_{R}^{l} = {\sum }_{( ℕ , 𝕏 )} ( Pr [ \begin{matrix}{Y}_{R} < {m}_{l} \vert {S}_{1} = \\ ( {N}_{1} , {X}_{1} ) , {S}_{2} = \\ ( {N}_{2} , {X}_{2} ) , … , {S}_{j} = \\ ( {N}_{j} , {X}_{j} )\end{matrix} ] \times Pr [ \begin{matrix}{S}_{1} = ( {N}_{1} , {X}_{1} ) , {S}_{2} = \\ ( {N}_{2} , {X}_{2} ) , … , {S}_{j} = \\ ( {N}_{j} , {X}_{j} )\end{matrix} ] ) \\ = {\sum }_{( ℕ , 𝕏 )} ( {p}_{{m}_{l}} ( ℕ , 𝕏 ) \times {\prod }_{k = 1}^{j} Pr [ {S}_{k} = ( {N}_{k} , {X}_{k} ) ] ) \\ = {\sum }_{( ℕ , 𝕏 )} ( {p}_{{m}_{l}} ( ℕ , 𝕏 ) \times {\prod }_{k = 1}^{j} {G}_{( {N}_{k} , {X}_{k} )} )\end{matrix} \qquad ( 18 )$$

The blocking of a multi-hop connection operating at line rate l can be determined using the Inclusion-Exclusion principle over the steady state probabilities of fiber links along the route as shown in Eq. 19.

$${B}_{R}^{l} = {\sum }_{[ 1 \leq k \leq j ]} {\sum }_{( ( {N}_{k} , {X}_{k} ) \vert γ - {X}_{k} < {m}_{l} )} {G}_{( {N}_{k} , {X}_{k} )} - ( {\sum }_{[ 1 \leq k < f \leq j ]} {\sum }_{( ( {N}_{k} , {X}_{k} ) \vert γ - {X}_{k} < {m}_{l} )} {\sum }_{( ( {N}_{f} , {X}_{f} ) \vert γ - {X}_{f} < {m}_{l} )} {G}_{( {N}_{k} , {X}_{k} )} \times {G}_{( {N}_{f} , {X}_{f} )} ) + ( \begin{matrix}{\sum }_{[ 1 \leq k < f < x \leq j ]} {\sum }_{( ( {N}_{k} , {X}_{k} ) \vert γ - {X}_{k} < {m}_{l} )} {\sum }_{( ( {N}_{f} , {X}_{f} ) \vert γ - {X}_{f} < {m}_{l} )} {\sum {G}_{( {N}_{k} , {X}_{k} )} \times }_{( ( {N}_{z} , {X}_{z} ) \vert γ - {X}_{z} < {m}_{l} )} \\ {G}_{( {N}_{f} , {X}_{f} )} \times {G}_{( {N}_{z} , {X}_{z} )}\end{matrix} ) … + ( {( - 1 )}^{j - 1} {\sum }_{( ( {N}_{1} , {X}_{1} ) \vert γ - {X}_{1} < {m}_{l} )} {\sum }_{( ( {N}_{2} , {X}_{2} ) \vert γ - {X}_{2} < {m}_{l} )} , … , {\sum }_{( ( {N}_{j} , {X}_{j} ) \vert γ - {X}_{j} < {m}_{l} )} {\prod }_{k = 1}^{k = j} {G}_{( {N}_{k} , {X}_{k} )} ) + ( {\sum }_{( ( {N}_{1} , {X}_{1} ) \vert γ - {X}_{1} \geq {m}_{l} )} {\sum }_{( ( {N}_{2} , {X}_{2} ) \vert γ - {X}_{2} \geq {m}_{l} )} … {\sum }_{( ( {N}_{j} , {X}_{j} ) \vert γ - {X}_{j} \geq {m}_{l} )} {\prod }_{k = 1}^{k = j} {G}_{( {N}_{k} , {X}_{k} )} \times {p}_{{m}_{l}} ( ℕ , 𝕏 ) ) \qquad ( 19 )$$

In step 106, the inventive method finds the difference in the blocking probability of a connection operating at each link rate l along each route R between subsequent iterations. If this difference is smaller than the accuracy threshold c, then the procedure stops, otherwise the invention repeats Step 102. At the last step, 107, the invention returns the blocking of a connection operating at each line rate l along each route R, B^{l}_{R}

The permutation method finds the number of permutations Nᵢ connections occupying Xᵢ wavelength slots in the spectrum availability profile that has at least mₗ consecutive wavelength slots starting from a wavelength slot k.

In the first step, 201, the invention first determines the number of connections for each type of line rate in the state (Nⱼ, Xⱼ) from Eq. 1 and Eq. 2. In the next step, 202, the inventive method constructs a set A by adding the found connections, and adds W in the set A for (γ-Xₘ-mₗ) number of times, where W represents a vacant wavelength slot.

In the third step, 203, the inventive method finds feasible subsets Bᵢ of the set A such that sum of the wavelength slots required by the connections in the subset is equivalent to (k−1) using an optimal solution of the subset sum problem. The found subsets must be unique Bᵢ≠Bⱼ for i≠j. In the next step, 204, the inventive method determines the number of permutations of connections in each subset B, and A-Bᵢ, for all i.

Lastly, step 205, the inventive method returns the total number of permutations;

$${\sum }_{i} ( \begin{matrix}the number of permutations of connections in the subset {B}_{i} \times \\ the number of permutations of connections in the subset A - {B}_{i}\end{matrix} )$$

From the foregoing it can be seen that the present invention provides a number of substantial benefits. The inventive method is applicable in estimating the connection blocking probability in FWDM networks, and can be applied to estimate the network capacity in green-field network planning phase or brown-field network upgrade phase. The blocking estimation method is the first procedure to evaluate the connection blocking in FWDM networks. The employed Markovian model concisely represents the states of a fiber in FWDM networks, accurately estimates the steady state probabilities of a fiber in FWDM networks, and accurately estimates the single-hop connection blocking in FWDM networks. The inventive blocking estimation method provides a reasonable estimation of blocking for multi-hop connections in FWDM networks. The inventive blocking estimation method is analytical, which can be used to estimate the connection blocking without extensive experimental simulations.

Having described preferred embodiments of a system and method (which are intended to be illustrative and not limiting), it is noted that modifications and variations can be made by persons skilled in the art in light of the above teachings. Additional Information related to the application herein is provided in the Appendix to Specification filed herewith. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for blocking estimation to evaluate connection blocking in flexible optical wavelength division multiplexing WDM networks, the method comprising the steps of:
i) initializing blocking of a connection operating at line rate l along the route R, with blocking probability B^{l}_{R}, to 0, and initializing the blocking of the connection in the previous iteration b^{l}_{R} to 0;
ii) recording the blocking connection in the current iteration B^{l}_{R} into the blocking of the previous iteration b^{l}_{R} for each line rate l and each route R;
iii) determining steady state probabilities G_{Nj, Xj} of each fiber link j using a Markovian model which includes finding a state transition diagram for each fiber link j;
iv) determining a state dependent arrival rate for each line rate l over each fiber j, α^{l}ⱼ(Nⱼ, Xⱼ);
v) finding the blocking of a connection;
vi) finding the difference in the blocking probability of a connection operating at each link rate l along each route R between subsequent iterations, if the difference is smaller than an accuracy threshold ε, then the method stops, otherwise the method repeats step ii); and
vii) determining a blocking of a connection operating at each line rate l along each route R, B^{l}_{R}.

2. The method of claim 1, wherein said initializing step comprises, for each link j, the potential states (Nⱼ, Xⱼ), and for each line rate l, initializing α^{l}ⱼ(Nⱼ, Xⱼ)=0, if (γ-Xⱼ)=0, otherwise it initializes
$${α}_{j}^{l} ( {N}_{j} , {X}_{j} ) = {\sum }_{R : j ∈ R} {λ}_{l}^{R} ,$$
where

3. The method of claim 1, wherein said step iii) comprises the blocking probability of a connection operating at line rate l on a fiber j, C^{l}ⱼ, being obtained from steady state probabilities G_{Nj,Xj} of a fiber j being in a state (Nⱼ, Xⱼ), and α^{l}ⱼ(Nⱼ, Xⱼ) is the arrival rate of a connection operating at line rate l on a fiber j when the state of the fiber is (Nⱼ, Xⱼ).

4. The method of claim 1, wherein said step iv) determining is based in part on λ^{R}ₗ which is the arrival rate of connections operating at line rate l over the route R, if a route R consists of a single link {j} and (γ-Xⱼ)≧mᵢ, then Pr(Y_{R}≧mₗ|Sⱼ=(Nⱼ, Xⱼ))=1 and for a multihop route R={1, 2, . . . , 10, Pr(Y_{R}≧mₗ|Sⱼ=(Nⱼ, Xⱼ)) is determined using a total probability theorem.

5. The method of claim 1, wherein the step v) finding a blocking of a connection comprises the blocking of a connection along the multi-hop route R={1, 2, 3, . . . , j} being determinable where a second equality is obtained with an assumption of link independence.

6. The method of claim 1, wherein the state (Nⱼ, Xⱼ) of step iv) is employed for finding a number of permutations Nᵢ connections occupying Xᵢ wavelength slots in the spectrum availability profile that has at least mᵢ consecutive wavelength slots starting from a wavelength slot k.

7. The method of claim 6, wherein finding a number of permutations comprises determining the number of connections for each type of line rate in the state (Nⱼ, Xⱼ).

8. The method of claim 7, wherein finding a number of permutations comprises constructing a set A by adding the found connections, and adds Win the set A for (γ-Xₘ-mₗ) number of times, where W represents a vacant wavelength slot.

9. The method of claim 8, wherein finding a number of permutations comprises finding feasible subsets B, of the set A such that sum of the wavelength slots required by the connections in the subset is equivalent to (k-1) using an optimal solution of the subset sum problem with the found subsets having to be unique Bᵢ≠Bⱼ for i≠j.

10. The method of claim 9, wherein finding a number of permutations comprises determining a number of permutations of connections in each subset Bᵢ and A-Bᵢ, for all i.

11. The method of claim 10, wherein finding a number of permutations comprises returning a total number of permutations;
$${\sum }_{i} ( \begin{matrix}the number of permutations of connections in the subset {B}_{i} \times \\ the number of permutations of connections in the subset A - {B}_{i}\end{matrix} )$$
